(19) United States
(12) Patent Application Publication
(10) Pub. No.: US 2015/0212866 A1
(43) Pub. Date: Jul. 30, 2015

(54) MANAGEMENT SYSTEM FOR SERVICE OF MULTIPLE OPERATING ENVIRONMENTS, AND METHODS THEREOF

(71) Applicant: Ching-Feng Lee, Fongyuan (TW)

(72) Inventor: Ching-Feng Lee, Fongyuan (TW)

(21) Appl. No.: 14/604,235

(22) Filed: Jan. 23, 2015

(30) Foreign Application Priority Data
Jan. 29, 2014 (TW) 103103486

(51) Int. Cl. G06F 9/54; G06F 9/44

(52) U.S. Cl. CPC G06F 9/542; G06F 9/4408

(57) ABSTRACT

Disclosure is related to a management system for service of multiple operating environments and a management method. The management method in accordance with the present invention includes the following steps. In a first step, a management program is executed after entering an initial operating environment. The management program is for creating image files with respect to the multiple operating environments. The initial operating environment is operated in a client device. When the management program in the initial operating environment detects at least one of the elements in the initial operating environment has been changed in the client device, the management program creates a new operating environment image. The new operating environment includes a snapshot of the initial operating environment and a difference portion which constitutes the changed elements. The management program is configured to set up an index map to the initial operating environment image and the difference image.

### BACKGROUND

1. Technical Field

The present invention generally relates to a management system and a method for a service of multi-operating environment; in particular, to a multi-operating environment which is based on the multiple image files created by the user or system administrator who modifies the operating environment, and to the management system and method provided for the user to select one of the operating environments.

2. Description of Related Art

Booting procedure for a computer system mainly begins by a Basic Input Output System (BIOS) which is initiated to perform a startup POST (Power On Self Test). In POST, the software or hardware is initialized. Any auxiliary booting device will be scanned for loading an operating system. In the auxiliary booting device, the operating system can be successfully loaded during the booting procedure. The mentioned auxiliary booting device is usually a hard disk, floppy, CD-ROM, or other portable storage such as USB drive. A boot loader is installed in the auxiliary booting device. The boot loader defines the system configuration, and the related environmental parameters, which are loaded into a kernel of the operating system in the earlier phase.

When using the regular computer system, different users may individually have their preferred system environments. For example, the operating system may be fitted to various requirements of the computer system such as to the users who may require the configurations and applications for performing scientific computation or conducting words processing.

In the conventional technology, an aspect of multi-operating environment in a computer system has been developed to content the various requirements. While the computer system with multi-operating environment with various configurations launches, a user may select one of the operating systems to go on the booting procedure. An operating environment having an operating system and the applications installed therein can be well defined. The different operating environments may separately content various requirements to the computer system.

Reference is made to FIG. 1. FIG. 1 shows a schematic diagram describing a computer system having multi-operating environments according to the conventional technology. A computer 1 has a disk 11 which is divided into several partitions, for example the partitions are given the labels of 111a through 111n. The each of partitions (111a through 111n) stores one operating system. The operating system is given the labels of OS 1 through OS N.

The user may enter one of the operating systems in the partitions of the computer 1 as the user requires when booting the computer 1. The computer 1 with multi-operating environments meets the various needs of the user.

FIG. 2 shows one further schematic diagram showing a disk with multi-operating environments in the conventional technology. The partitions of disk 2 separately store different operating environment given the labels of 21a to 21d. For example, the operating environment 21a is made to have an operating system (OS 1) and applications (APP 1, 2) installed in the operating system OS 1. The operating environment 21b has an operating system (OS 1) and the installed applications (App 1, 2, 3). The operating environment 21c is made to have an operating system (OS 2) and application (APP 1) is installed therein. The operating environment 21d is made to have an operating system (OS 3) and the inside application (App 2). As the FIG. 2 shows, the user is permitted to install a selected operating system and the preferred applications in one of the partitions so as to constitute a specific operating environment. The operating system in one of the partitions will be initiated according to the user's selection as booting the computer system. The aspect contents the user's various needs, or different users.

In conventional technology, a program such as GHOST is used to create an image file with respect to a disk or one of the partitions. The image file may be then restored to one disk or partition in another computer. Therefore, the same operating environment may be easily copied to other computers.

When the user wants to modify part of the selected operating environment, for example to modify the operating environment 21a with the operating system OS 1 and the applications App 1, 2, a new environment is created. Similarly, when the user installs a new application APP 3 into the operating environment 21a, the operating environment 21a becomes the shown operating environment 21b with installations of the applications App 1, APP 2, and APP 3. The user is allowed to back up the operating environments separately before and after modifying the operating environment 21a. Accordingly, both the two exemplary operating environments have the duplicated operating system OS 1 and applications App 1, 2 and those duplicate files occupy too much space. The space may be substantially regarded as waste storage. Further, it spends much time to build multiple GHOST image files with respect to the hard disk or partitions installed with the operating system and the various applications when the environments are implanted into multiple computers. If the computer system is configured to conduct rollback to previous timing, a backtracking point needs to be tagged to the operating environment before change. The conventional rollback mechanism provides no efficiency since it consumes too much time.

### SUMMARY

In view of the drawback of consuming the storage when preparing various operating environments in the conventional technology, provided in accordance with the present invention is to a management system for service of multi-operating environments and a method thereof. The management system allows the multi-operating system to efficiently create image files with respect to the multiple operating environments. Within the management system, the system merely creates the image file corresponding to the changed portion from the original operating environment. Further, the index maps can be established to correlate with the multiple operating environments. Therefore, the storage required to back up the operating environments is substantially reduced when compared to the conventional technology which require much space to store the duplicated components. The multi-operating system efficiently saves the overall space for storing the operating environments and improves the speed to conduct the rollback to a specific operating environment. The system, according to the present invention, also enhances the performance to install the operating environments to the multiple computers. The rollback operation for the specific operating environment is equivalent to selecting the operating environment as requires without any further user operation.

The embodiments in the description according to the present invention are related to a management method of a service for multi-operating environment. The method for establishing a multi-operating environment includes following steps. In the beginning, the process enters an initial operating environment and executes a management program. The management program is used to manage the multi-operating environment installed in a hard disk. The program is able to acquire the any change in the beginning or of the every operating environment. The change of element within the environment is such as newly installing, upgrading or updating any application, driver or program, patching the operating system, or even installing a plug-in program.

The initial operating environment may operate in a client device. When the management program detects a change of at least one element within the initial operating environment in the client device, a new operating environment may be created. This new operating environment includes an image file created with the changed element. The management program then sets an index map correlated with the initial operating environment and image file having the changed element.

According to the management system for the service of a multi-operating environment in one embodiment of the present invention, the management system includes a server and at least one client device. The client device has a first memory unit, a management program, and a first processing unit. The first memory unit stores an initial operating environment in the beginning. The management program can be used to create the image file for the multi-operating environment. The management program is executed as entering the initial operating environment. When management program detects any change of at least one element in the initial operating environment in the client device, a new operating environment is established. The new operating environment has the image file including the changed element. The management program then sets an index map to make a correlation with the initial operating environment and the change.

In sum, the management system and method for the service of multi-operating environment are disclosed. In which, aspect adopting the image file with the changed element which may be added or deleted allows the system reducing the space for the multi-operating environment. This aspect also increases the efficiency to perform a rollback process to the any operating environment. Furthermore, the aspect allows efficiently installing the any operating environment to multiple computers.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a diagram illustrating a computer having a multi-operating system according to a conventional technology;

FIG. 2 shows a medium installed with a multi-operating environment according to a conventional technology;

FIG. 3A schematically shows a diagram depicting adding new software element in a management system for service of multi-operating environment in one embodiment of the present invention;

FIG. 3B schematically depicts updating software element in the management system for service of multi-operating environment in one further embodiment of the present invention;

FIG. 4 schematically depicts the image file created in the management system for service of multi-operating environment in one embodiment of the invention;

FIG. 5 shows a schematic diagram depicting a system framework of the management system for service of multi-operating environment according to the present invention;

FIG. 6 shows a circuit block diagram illustrating the management system for service of multi-operating environment according to the present invention;

FIG. 7 shows a flowchart illustrating the method for managing a multi-operating environment in one embodiment of the present invention;

FIG. 8 shows a flowchart illustrating the method in one further embodiment of the present invention;

FIG. 9 shows a flowchart illustrating a management method for creating image file within a multi-operating environment according the present invention;

FIG. 10 is a flowchart illustrating a rollback process for the multi-operating environment of the present invention.

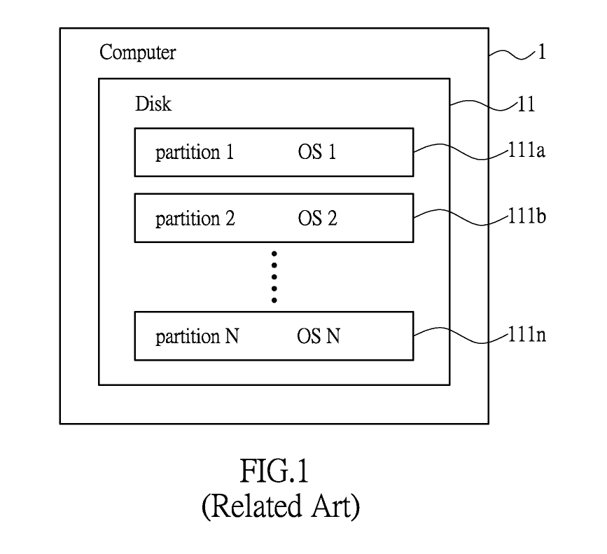

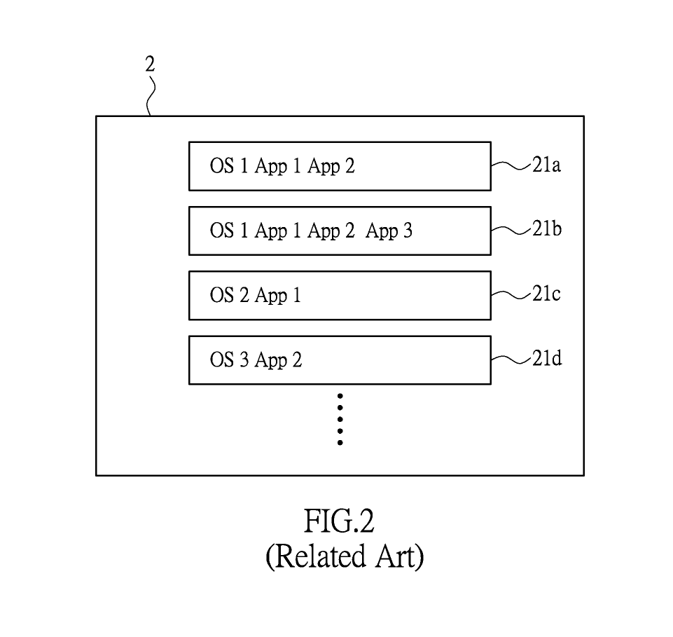

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

According to the description in accordance with the present invention, the operating environment is defined to have an operating system and the applications installed in the operating system.

Provided in the description is to a management system for service of multi-operating environments, it's for saving an overall storage prepared for the operating environment, increasing efficiency to install operating environments to multiple computers, and to perform rollback process of any operating environment. One of the major features of the present invention is to create the image file which packages the operating environment before or after its modification is made within a multi-operating environment. This aspect effectively reduces the space consumed by the multi-operating environment.

In addition, by the method for managing the service of multi-operating environment, the system administrator may efficiently install multiple operating environments into multiple computers using the image files having the multiple operating environments. This aspect increases performance of data reading and throughput when the installation is based on these image files.

Further, the method also allows the user to perform a rollback process back to a previous version of operating environment. It is featured that the any version of operating environment may be created as reducing traffic for data reading and transmission rather than the conventional way. It is noted that the aspect of the present invention to manage the multi-operating environment effectively reduces the space of storage device. Further, the rollback process can be speeded up under this aspect.

The following description of embodiments is for use to clarify the present invention.

Embodiment of managing the multi-operating environment when the element is modified:

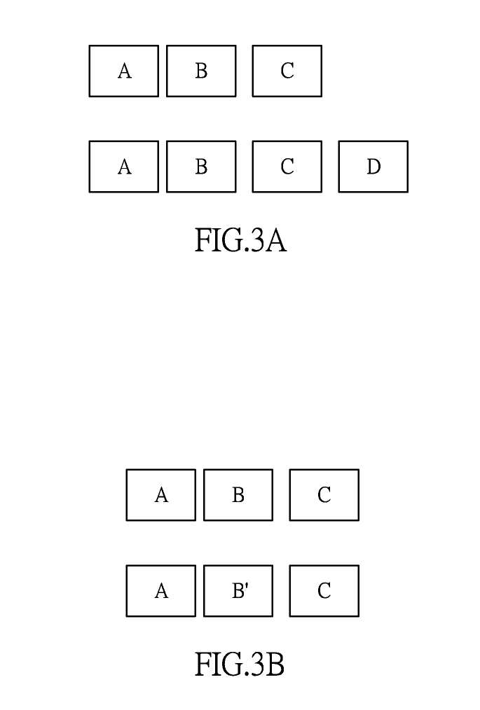

Reference is made to FIG. 3 showing a diagram depicting the system for the service of multi-operating environment when a software element is changed.

In this exemplary embodiment, the initial or the previous operating environment is supposed to have elements A, B, and C. For example, the element A is such as an operating system. The management system for the service of multi-operating environment may be widely applied to various operating systems. For example, the operating systems are such as UNIX, Linux, Windows, Mac OS, and even the OSs for portable electronics, e.g. Android, iOS, and Windows Phone. The elements B and C are such as the applications, drivers, plugin programs installed in the operating system (element A), or the any patching, updating, upgrading program thereof. It is noted that the mentioned applications are exemplified by installed word processing software, game program, or any other application.

The any modification made to the element within the operating environment may relate to the files generated by patching, updating, or upgrading the operating system including drivers or applications. The modification made to the operating environment may be the parameter configuration with respect to the OS or applications operated by the user since the configuration may require new parameter. In other words, the any modification of the parameters for the OS or applications may be regarded to modification of the elements as compared with the previous version.

Still further, the part of elements may be regarded as the modification when the operating system or applications within the operating environment is updated since the updating process may make some changes thereof. Further, the user may install any new application into the operating environment, and therefore the content of the operating environment is added. Further, when any new user account is created in the operating environment, the operating environment stores the new user setting in the operating system. It means that new elements are added in the operating environment.

The above mentions of any change made to the operating environment will result in modifying the operating environment. In sum, the modifications made to the operating environment can be categorized into two actions which are new adding and updating. The operating system is changed when the user makes new adding or updating process to the operating environment. In short, the management system for the service of multi-operating environment will differentially create and store an image file at different operating stages thereof if any modification is made to the operating environment.

Reference is made to FIG. 3A. FIG. 3A schematically shows newly creating differential image file as installing new software element in the multi-operating environment.

As shown in FIG. 3A, an initial operating environment or the previous version of operating environment includes three elements A, B, and C. For example, when new element D such as new application is installed in the initial operating environment, the new element D is added to the initial operating environment as shown.

The management system then creates a new image file with respect to the new environment including the initial elements A, B and C and the new element D. The image file includes all the modifications made to the initial operating environment at this stage. According to one of the embodiments of the present invention, the management system compares the operating environments before and after the modification is made. The image file is differentially created by comparing the initial operating environment with the later operating environment having the element D. It means the image file of initial operating environment before modification has the exemplified elements A, B and C; the new image file for the modification is with respect to the new operating environment having the elements A, B, C and D. The new operating environment is constituted of the image file of initial operating environment and the differentially-created image file having the element D.

Reference is next made to FIG. 3B schematically describing the differentially-created image file when the management system updates a software element in the operating environment.

The initial operating environment is supposed to have three elements A, B and C. When the element B of the initial operating environment is updated, for example patching or updating version of the operating system and/or application, the element B is patched or updated to be the element B′, as shown in FIG. 3B.

After that, the management system for the service of multi-operating environment acknowledges the modified element (B′). The management system will keep the image file and information related to the previous operating environment, and record the modification status with respect to the initial operating environment. It means a new image file will be created to involve the modification made to the operating environment, and therefore both two image files are stored. The image files reflect two different operating environments respectively having the element B and the element B′. It is noted that the two image files are differentially created to render two operating environments. The differential storing technology is utilized to keep the initial operating environment with the elements A, B, and C, and the later operating environment with the elements A, B′, and C.

By the management system of the present invention, the every modification made to the initial operating environment creates a new element so as to establish a new operating environment, and also a new image file. When the user desires to back to any operating environment, the system provides options with respect to the multiple operating environments. The every option of operating environment indexes the information and related image files. The one selected operating environment will be established to involve the related image files as performing the rollback process. Under this scheme, all the elements after the modification may constitute a new image file, and the common elements such as the elements A, B, and C in the example of FIG. 3A, or the elements A and C in FIG. 3B may cause reduction of capacity.

Embodiment of structure of image files made by the management system for service of multi-operating environment:

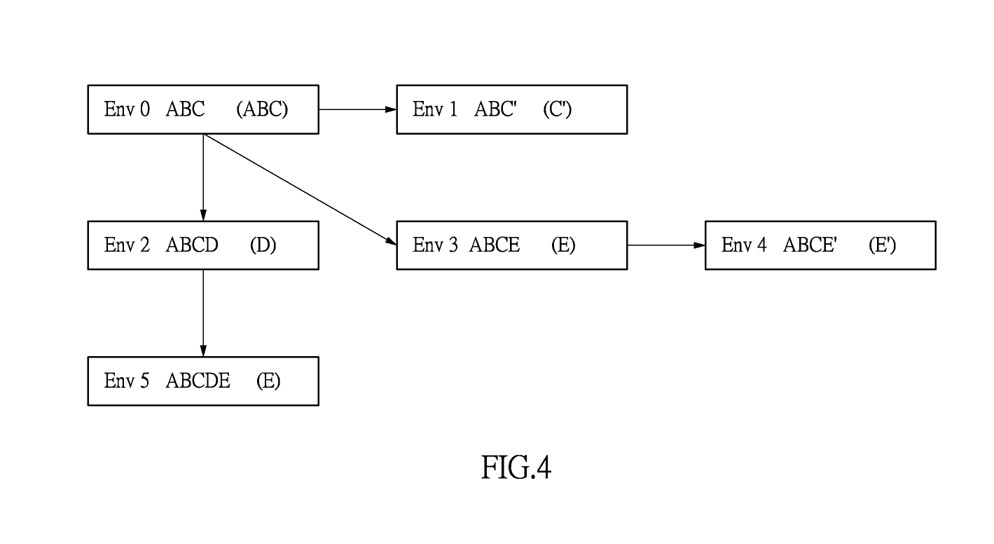

A management method for the service of multi-operating environment according to one embodiment of the present invention is disclosed. The management system is able to efficiently save the storage space for the operating environments. The system also records the initial operating environment and every modification and order for the operating environments. Reference is made to FIG. 4.

FIG. 4 shows a schematic diagram depicting structure of image files related to every operating environment by the management system. In the beginning, the initial operating environment is exemplarily as an operating environment 0 (Env 0) which is indexed as “0”. The elements of operating environment 0 (Env 0) are exemplified as A, B, and C. The elements A, B, and C render an image file of Env 0. When the user selects the operating environment 0 (Env 0), the system assembles the elements A, B, and C to constitute the operating environment 0.

Next, when the element C of the operating environment 0 (Env 0) is updated to element C′, a new operating environment 1 (Env 1) is established, and indexed as “1”. Therefore, the elements A, B, and C′ constitute the operating environment 1 (Env 1). An image file with respect to the element C′ may reflect the operating environment 1 (Env 1). A graphic relationship may be referred to a horizontal relationship between the operating environment 0 (Env 0) and the operating environment 1 (Env 1). When the operating environment 1 (Env 1) is selected, the structural relationship makes the system to assemble the image files associated to the operating environment 0 (Env 0) and operating environment 1 (Env 1). The graphic relationship shows the Env 1 is updated from Env 0 so as to constitute the Env 1 based on the elements A, B, and C′.

In addition, the graphic relationship and index maps relating the operating environment 0 (Env 0) and the operating environment 1 (Env 1) may be stored in a table. The index map contains pointers to the elements of a specific image file, and also to a menu provided for the system to perform multiple booting.

According to one further embodiment, the image files for constituting the any operating environment may be stored in one file server. The files in the file server are provided for any serving system or terminal. The image files may also be stored in one local storage device or local serving system. The serving system may store the image files associated to the multiple operating environments which are provided for any terminal to boot up a selected operating environment. However, if the any required image file is not stored in the serving system, a link to the image file may be created. In short, the location and type of image file may not limit the embodiments of the present invention. Compared to the aspect of image created for any operating system in the conventional technology, an image file of the new element (C′) can be individually created but not including the duplicated elements (A and B).

Further in one example, when a new element D is added in the operating environment 0 (Env 0), a new operating environment 2 (Env 2) is created, and an index “2” is made. The elements A, B, C, and D constitute the operating environment 2 (Env 2). The image file of element D indicates that the operating environment 2 (Env 2) has the element D. The graphic relationship between the operating environment 0 (Env 0) and the operating environment 2 (Env 2) shows a downward connection from the operating environment 0 (Env 0). When the user selects Env 2 to be the operating environment, the system acknowledges the relationship between the operating environment 0 (Env 0) and the operating environment 2 (Env 2) and assembles the image files thereof. The operating environment 2 (Env 2) with the elements A, B, C, and D is formed.

The graphic relationship and index maps associating the operating environment 0 (Env 0) and the operating environment 2 (Env 2) are recorded to a table. The index map there-between contains pointers to the elements of the image file. Compared to the conventional way to record those environments, the only element D is made to be image file other than the elements A, B, and C.

Similarly, when a new element E is added to the operating environment 0 (Env 0), another new operating environment 3 (Env 3) is established, and indexed as “3”. The elements A, B, C, and E constitute the operating environment 3 (Env 3). The element E indicates the image file associated to the operating environment 3 (Env 3). The graphic relationship between the operating environment 0 (Env 0) and operating environment 3 (Env 3) shows a downward connection to the Env 3 from Env 0. When the user selects operating environment 3 (Env 3), the system assembles the necessary image files related to the Env 0 and Env 3 based on the structural relationship. From the graphic relationship, it is acknowledged that the new operating environment 3 (Env 3) is based on Env 0, and the related elements A, B, C, and E therefor.

Also, the graphic relationship and index maps thereto are recorded to a table. The index map contains pointers to the necessary elements. In the example, the only element E is required to be stored other than the other elements A, B, and C.

Further, if the element E of operating environment 3 (Env 3) is updated to element E′, a new operating environment 4 (Env 4) is established, and indexed as “4”. The elements A, B, C, and E′ constitute the operating environment 4 (Env 4). “E′” indicates the image file of the operating environment 4 (Env 4) having the element E′. The graphic relationship between the operating environment 3 (Env 3) and the operating environment 4 (Env 4) shows a horizontal connection there-between. When the user selects the operating environment 4 (Env 4), the system assembles the image files of the Env 3 and Env 4 based on the relationship. The system acknowledges the operating environment 4 (Env 4) is updated from Env 3 and having the elements A, B, C, and E′.

Also, the graphic relationship and index maps between the operating environment 3 (Env 3) and the operating environment 4 (Env 4) are recorded to a table. Index map is directed to the image file. Only the element E′ is required to be stored as a new image file other than the elements A, B, and C.

When a new element E is added in the operating environment 2 (Env 2), a new operating environment 5 (Env 5) is established. An index thereto is “5”. The elements A, B, C, D, and E constitute the operating environment 5 (Env 5). The “E” indicates the image file of the operating environment 5 (Env 5) having the element E. The graphic relationship between the operating environment 2 (Env 2) and the operating environment 5 (Env 5) shows a downward connection from the operating environment 2 (Env 2) to the operating environment 5 (Env 5). When the user selects to boot the system using the operating environment 5 (Env 5), the system assembles the necessary image files of the Env 5 and Env 2 based on the relationship. The system will acknowledges the Env 5 is established based on the operating environment 2 (Env 2), and the related elements A, B, C, D, and E.

The graphic relationship and the index maps between the Env 2 and Env 5 are stored in a table. The index map contains pointers to the element of image file. Compared to the conventional technology, the only element E is required to be an image file other than the duplicated elements A, B, C, and D.

The foregoing examples show the management system for the service of multi-operating environment renders a graphic relationship among the operating environments. Through the table recording the structural relationship, the management system may conveniently show the image files associated to the any modification made to the multiple operating environments.

Embodiment of the management system for service of multi-operating environment:

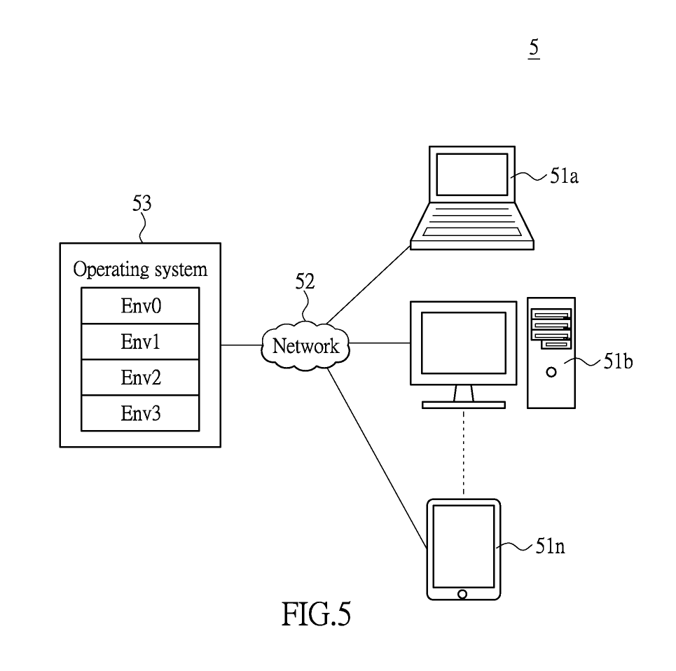

FIG. 5 shows a system framework of the management system according to one embodiment of the present invention. The management system 5 includes multiple client devices 51a to 51n, and a serving system 53 having the multiple operating environments Env0, Env1, Env2, and Env3. The client devices 51a to 51n as shown in the diagram are such the various electronics, especially the devices requiring some specific operating systems. For example, the device is a smart phone, personal digital assistant (PDA), a tablet PC, laptop computer, desktop computer or other computer device available to installing and executing programs. The client devices 51a to 51n may be connected to the serving system 53 over network 52 to conduct data transmission.

The client devices 51a to 51n may separately connect to the serving system 53 over the network 52. These client devices 51a to 51n may be, but not limited to, connected to the serving system 53 through wired or wireless connection directly or via a relay. It is noted that the management system of the present invention may either use the serving system 53, or the local storage device to store the image files.

In an exemplary embodiment, the serving system 53 stores the various image files which are created based on the modifications made to the operating environments (Env0, Env1, Env2, Env3) at different stages by the client devices 51a to 51n. Alternatively, the image files may be stored in the local storage device (not shown in FIG. 5). When any new element added at the client device is transmitted to the serving system 53, the serving system 53 accordingly creates a new image file based on the stored files. Those image files may be stored in the serving system, or a local storage device at the client end.

It is noted that, in the multi-operating environment, the implementation of the serving system 53 may not be limited to the aforementioned figures, but to any type of the servers.

According to the present embodiment, a management program can be installed in any of the client devices 51a to 51n in the management system 5. Therefore, the management program may be utilized to monitor any modification to the operating environment made in the client device. The management program is used to manage selection, monitoring and delivery in the multi-operating environment.

When the operating environment in one client device is modified, the management program will find this change. The program may then create an image file associating the portion in modification, and also record the structural relationship of before or after the modification, and index map to a table.

Embodiment of the management system for service of multi-operating environment:

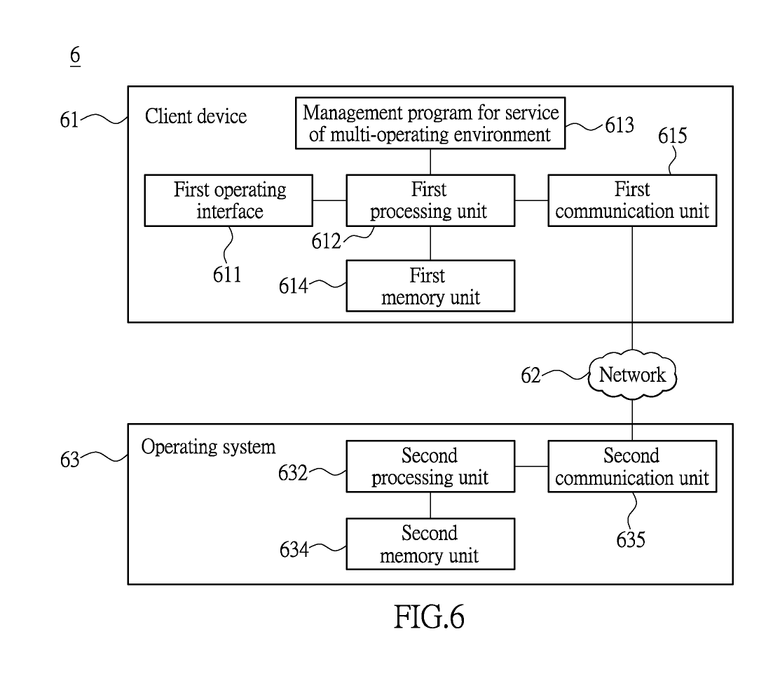

The management system for the service of multi-operating environment is exemplarily described as follows. FIG. 6 shows a circuit block diagram to describe the management system. A management system 6 includes a client device 61 and a serving system 63. The client device 61 is connected to the serving system 63 over a network 62.

The client device 61 is such as a smart phone, personal digital assistant, tablet PC, laptop computer, desktop computer, or other computer device available to install or execute programs.

The client device 61 includes a first operating interface 611, a first processing unit 612, a management program 613 for multi-operating environment, a first memory unit 614, and a first communication unit 615. The operating interface 611, the management program 613, the first memory unit 614, and the first communication unit 615 are individually coupled to the first processing unit 612.

The operating interface 611 is used to provide the user of client device 61 to operate the commands made by the device 61. The command is such as patching, upgrading, adding, updating the operating environment or program at the client device 61. The command may also instruction to configure parameters of the operating environment.

The first processing unit 612 is a main computing kernel of the client device 61. The first processing unit 612 is to activate and execute the OS and applications in the client device 61. Further, the first processing unit 612 allocates and manages the computing resource in the client device 61. The first processing unit 612 may be implemented as a microcontroller or embedded controller. The processing chip disposed in the client device 61 may be, but not limited to, implemented by means of code compilation.

The management program 613 may be an internal application installed in the client device 61. Alternatively, the management program 613 may be a program installed in the internal kernel mode layer, and used to monitor any modification made to the operating environment of the client device 61.

The first memory unit 614 is used to store a menu of the multi-operating environment, the initial operating environment shown on the menu, and the relationship and index map related to the operating environment with or without the modification. However, the files may not only be stored in the first memory unit 614 of the client device 61, but also part or all the files stored in a cloud device, removable storage, or other types of storage devices.

The management program 613 is used to monitor the operating environment executed in the client device 61. When the user modifies any element of the operating environment through the first operating interface 611 rendered in the client device 61, for example adding application, updating operating system or application, or configuring the operating environment, the management program 613 may prompt the user to make a decision whether or not creating a snapshot related to the image file of the previous version of operating environment.

When the user decides to create the snapshot with respect to the image file of the pervious operating environment, the image file may then be transmitted to the serving system 63 through the first communication unit 615.

The serving system 63 includes a second processing unit 632, a second memory unit 634, and a second communication unit 635. The second memory unit 634 and the second communication unit 635 are coupled to the second processing unit 632.

The second processing unit 632 is a main computing kernel of the serving system 63. The second processing unit 632 is such as a central processing unit (CPU) and used to allocate and manage the resource in the serving system 63.

The second memory unit 634 is used to store image files related to the multi-operating environment, and a table which records the relationship among the image files. Specifically, the second memory unit 634 is used to store the image file before and after the modification made to the operating environment by the user operating a first operating interface 611 in the client device 61. Those image files with respect to the various operating environments are provided for the user to select one of the operating environments. The management program accordingly assembles the required elements to constitute the selected operating environment.

The second communication unit 635 is communicated with the first communication unit 615 in the client device 61 over the network 62. The connection made between the client device 61 and the serving system 63 is used to deliver data there-between. However, the invention is not limited to the mentioned structure related to the first communication unit 615 and the second communication unit 635.

It is noted that, the first memory unit 614 and the second memory unit 634 may be, but not limited to, volatile or non-volatile memory such as hard disk, floppy disk, flash drive, or random-access memory.

In brief, when the user modifies operating environment of the client device 61 through a first operating interface 611. A management program 613, as a daemon of the operating system, is used to monitor the any modification made to the operating environment. The management program 613 also drives the first communication unit 615 to establish a connection with the serving system 63. The information of files such as the image file of initial operating environment and differential data with respect to the modification is transmitted to the serving system 63 through the first communication unit 615. The serving system 63 accordingly creates the image file of the operating environment. The serving system 63 may receive the data transmitted by the client device 61 via a connection over a network 62 made by the first and second communication units (615, 635). The differential image file associated to the operating environment may be stored in the second memory unit 634 of the serving system 63. The user is permitted to operate the selected operating environment through the first operating interface 611. The management program 613 is as a daemon executed in the client device reads the structural relationship and index map of the operating environment from the first memory unit 614. The management program 613 also drives the first communication unit 615 to establish a connection with the serving system 63. The management program 613 receives the image file of the operating environment from the serving system 63 through the second communication unit 635. Then the program 613 assembles the elements to constitute the selected operating environment.

Embodiment of a boot menu of multi-operating environment:

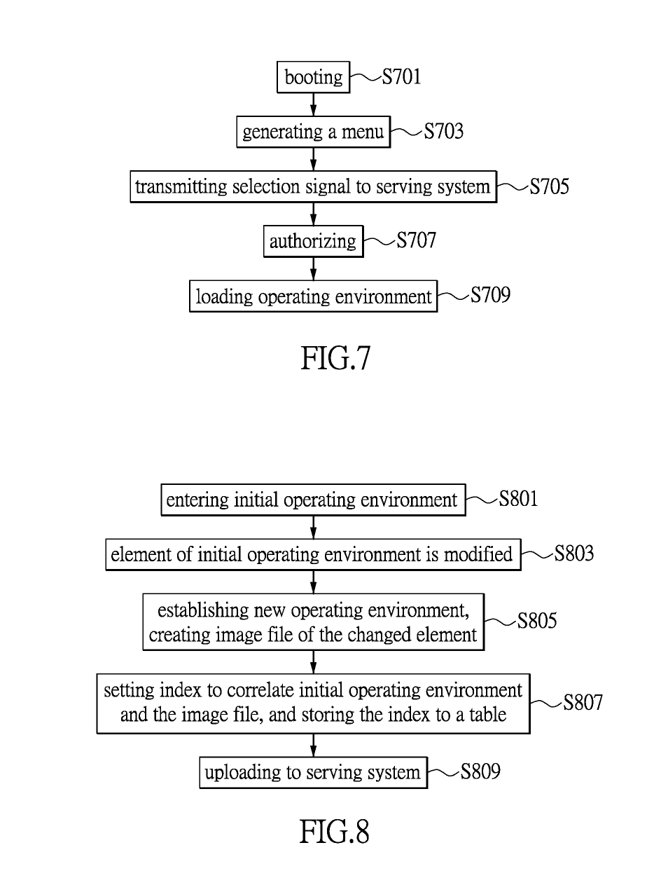

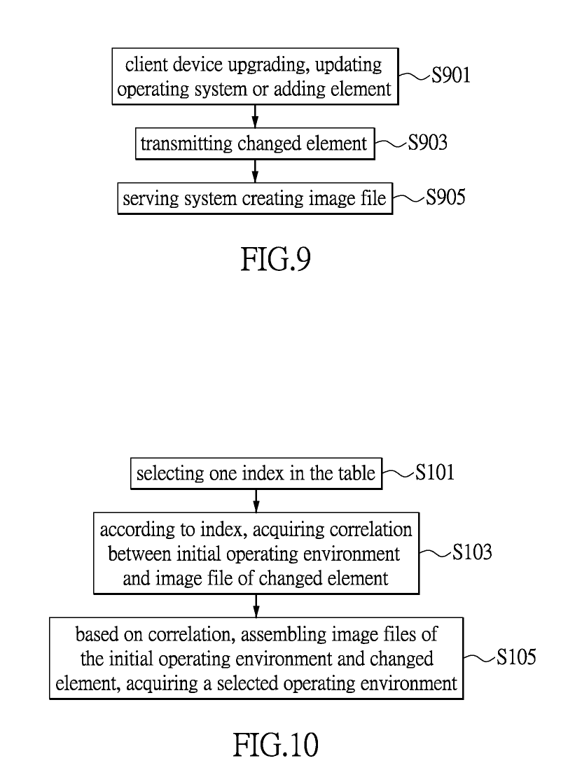

Reference is next made to FIG. 7, in view of FIG. 6. FIG. 7 shows a flowchart illustrating provision of a boot menu of the multi-operating environment.

At first, in step S701, the client device 61 boots up as the user turns on the power of client device 61. Next, in step S703, the client device 61 is activated to read out information of a boot menu relating to the multi-operating environment from the first memory unit 614 and display the menu. The menu is provided for the user to select an operating environment, or any operating environment listed in the menu. A selection signal is then generated in step S703. After that, in step S705, the selection signal is delivered to the serving system 63 over the network or any connection. The operating environment selected by the user according to the selection signal is loaded to the client device 61. It is noted that the selected operating environment is as an initial operating environment at this stage.

Inside the management system for service of multi-operating environment, serving system 63 records every registered and authorized client device(s) 61. In step S707, while the serving system receives a selection signal associated with the operating environment made by the client device 61, the system authorizes the device to assemble the one or more image files from corresponding sections for constituting the selected operating environment. The client device 61, in step S709, loads the operating environment while completing the booting process.

When the device is configured to load the initial operating environment in the booting process, the operating environment is firstly loaded to a memory of the device. The user is permitted to modify the element within the operating environment, including patching, updating, upgrading, or installing application, or modifying any setting of the environment. The management program in the client device 61 may therefore receive the information of the modification. The information of modification is transmitted to the serving system 63, and the system 63 will create an image file thereof. The newly created operating environment may also be one option listed in the menu of multi-operating environment in the booting process of the client device 61.

Further, when the client device 61 is next booted, the serving system 63 may actively reassemble the image files according to the previous booting information in addition to providing a menu for user's selection. The related operating environment may be delivered to the client device 61 for operation.

Embodiment of the management method for service of multi-operating environment:

Reference is made to FIG. 8, in view of FIG. 6. FIG. 8 shows a flowchart illustrating the method for managing the multi-operating environment.

In the beginning, in step S801, the user may select one of the operating environments from a menu of multi-operating environment. The client device 61 accordingly enters an initial operating environment. Next, in step S803, the user is permitted to modify the initial operating environment. For example, the modification is such as adding application, updating OS and application, or configuring parameters of the operating environment. In step S805, in the client device 61, a new operating environment is established while the operating environment is modified. An image file associated to the modified operating environment is created. The image file may be created in the serving system 63, or by the program in the client device 61. In step S807, in the client device 61, an index map may be set to correlate with the initial operating environment and the image file related to the modification. The structural relationship and index map for the operating environment before and after the modification are listed in a table. The table is stored in the first memory unit 614. At last, such as step S809, the elements or image files associated with the operating environment before and after the modification at the client device 61 can be transmitted to the serving system 63 through the first communication unit 615. While the serving system 63 receives the elements or image files from the client device 61 through the second communication unit 635, the files are stored in the second memory unit 634.

Embodiment of establishing image file in the management system:

While the operating environment is upgraded, updated or added with elements, such as step S901, the elements may be delivered to the serving system over network or any specific connection, such as step S903. The serving system therefore creates an image file therefor in step S905. These image files may be stored in a specific storage device, but not limited to the storage in serving system. An index map will be established to link the image files. The index maps allow the system to reassemble the related image files to constitute the operating environment as the user requires.

Embodiment of performing rollback process to previous operating environment in the management system:

Reference is made to FIG. 10, in view of FIG. 6. The flowchart shown in FIG. 10 illustrates the method for rolling back to any operating environment of the multi-operating environment.

In step S101, the user makes a selection of the operating environments listed in the menu through a first operating interface 611 in the client device 61. Next, in step S103, the management program in the client device 61 acknowledges the index maps related to the selected operating environment, and acquires relationship between the initial operating environment and the image files with respect to the changed portion. In step S105, the selected operating environment can be retrieved by assembling the elements of the image files according to the correlation. The process brings the user back to the previous version of operating environment.

To sum up, the management system for service of multi-operating environment and the method allow the user to operate various operating environments by assembling the image files according to the user's selection. The framework including a server end and the client end is provided. The operating environment is particularly initiated by the service of multi-operating environment over a network, for example using a Preboot eXecution Environmen (PXE) technology. The management program installed in the client end allows the remote administrator to install an operating environment to the client device over this service of multi-operating environment.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A management method for a service of multi-operating environment, comprising:
in a client device, entering an initial operating environment and executing a management program, wherein the management program is configured to manage selection, detection and delivery of the multi-operating environment;
creating a new operating environment when the management program detects at least one element in the initial operating environment is modified by the client device;
creating an image file with the at least one changed element of the new operating environment and adding an index map correlating the initial operating environment and the image file with the at least one changed element.

2. The method of claim 1, wherein the element indicates an operating system or an application.

3. The method of claim 2, wherein the change of element includes updating, upgrading, patching the operating system or the application, or a program file as adding a plugin program.

4. The method of claim 3, wherein the change of the element means parameter configuration to the operating system or the application.

5. The method of claim 1, wherein, before the step of entering the initial operating environment, comprising:
in process of booting the client device, providing a menu of multi-operating environment for selecting one of the operating environments to be the initial operating environment.

6. The method of claim 5, wherein the image file with the at least one changed element for the new operating environment is transmitted to a serving system or a local storage device over a network.

7. The method of claim 6, wherein the new operating environment becomes one of the options in the menu.

8. The method of claim 6, wherein the image file with the changed element is created when a new element is added at the client device, and then delivered to the serving system for storage; or directly stored into the local storage device.

9. The method of claim 1, wherein the index map contains pointers directed to the image file with respect to the changed element.

10. A management system for service of multi-operating environment, comprising:
a serving system, storing a plurality of image files with respect to multiple operating environments, or correlations to the plurality of image files; and
at least one client device, connected to the serving system over a network, wherein the client device comprises:
a first memory unit, loading an initial operating environment and a management program after booting, wherein the management program is used to manage operations of select, detect and deliver within the multi-operating environment; and
a first processing unit, electrically connected to the first memory unit, executing the initial operating environment and the management program as booting;
wherein, when the management program detects at least one element to be changed made in the client device in the initial operating environment, a new operating environment is created; the operating environment includes an image file made of changed element, and the management program is configured to have an index map correlated with the initial operating environment and the image file with respect to the changed element.

11. The system of claim 10, wherein the element is an operating system, or an application.

12. The system of claim 11, wherein the change with respect to the element includes updating, upgrading, patching of the operating system or the application, or a program file as adding a plugin program.

13. The system of claim 12, wherein the change with respect to the element includes parameter configuration or modification of the operating system or the application.

14. The system of claim 13, wherein the change with respect to the element is adding a user setting for the operating system.

15. The system of claim 10, wherein, before entering the initial operating environment, the management system provides a menu of a multi-operating environment, one of selections made in the menu is the initial operating environment.
